(19) United States
(12) Patent Application Publication
(10) Pub. No.: US 2003/0098878 A1
(43) Pub. Date: May 29, 2003

(54) URL database application

(76) Inventor: Ralph F. Conley JR., Miamisburg, OH (US)

Correspondence Address: Steven J. Rosen, 4729 Cornell Road, Cincinnati, OH, 45241, US

(21) Appl. No.: 09/994,552

(22) Filed: Nov. 27, 2001

(51) Int. Cl. G06F 3/00

(52) U.S. Cl. 345/748

(57) ABSTRACT

URL database software stored in machine readable format includes database software for storing URL links in a database on an end-user computer. The database has records and each of which has at least three fields relating to a single URL link stored in a first field. An editable URL title is stored in a second field and user entered notes are stored in a third field. The database software includes a URL navigation means for navigating the end-user computer to a URL site associated with a selected one of the first, second, and third fields. The exemplary embodiment of the invention includes means for entering the URL, means for entering the URL titles, and means for entering notes. The embodiment incudes means for grouping the URL links. Sort means, search means, and automated log-in means are also provided in more particular embodiments of the invention.

### BACKGROUND OF THE INVENTION

1. Field of the Invention

This invention relates generally to indexing and searching URLs in a computer network. More particularly, it relates to a systems, software, and methods for providing a user with a way to store, search, and retrieve Web pages in an Internet environment using a Web browser.

2. Discussion of the Background Art

Networking of computers and computer systems into a network of computer systems is a well known technique for sharing collective resources available within the network among users. The largest of these is the Internet, also referred to as the World Wide Web, or simply “the Web” and it provides the most commonly used method of transferring data in a networking environment. For a more detailed explanation, see U.S. Pat. No. 6,247,021 to Himmel et al. Transactions on the Web use the Hypertext Transfer Protocol (HTTP) which is a known application protocol providing users access to files, e.g., text, graphics, images, sound, video, using a standard page description language known as the Hypertext Markup Language (HTML). HTML provides basic document formatting and allows the developer to specify “links” to other servers and files. In the Internet paradigm, a network path to a server is identified by a Uniform Resource Locator (URL) having a special syntax for defining a network connection.

Retrieval of information is generally achieved by the use of an HTML-compatible “browser”, e.g., Netscape Navigator or Microsoft's Explorer, on a user's computer. When the user of the browser specifies a link via a URL, the client issues a request to a naming service to map a host-name in the URL to a particular network IP address at which the server is located. The naming service returns a list of one or more IP addresses that can respond to the request. Using one of the IP addresses, the browser establishes a connection to a server. If the server is available, it returns a document or other object formatted according to HTML. Web browsers have become the primary interface for access to many network and server services including intranets and extranets as well as the World Wide Web or Internet.

Browsers provide a useful means of returning to a favorite URL, by the creation of user stored “bookmarks” or “favorites” in the browser. Netscape uses the term bookmark while Explorer uses the term favorite. For the purpose of this patent, bookmark and favorites are used generically and interchangeably to denote and represent these terms and any other similar terms used to describe a saved URL. Lists of these bookmarks offer a means of Web page search and retrieval. The user can cause the browser to display his bookmark list and select among the stored bookmarks to go directly to a favorite page. Thus, the user is not forced to enter a lengthy URL nor retrace the original tortuous route through the Internet by which he may have arrived at the Web site. Once a bookmark is added to a bookmark list, in general, the bookmark becomes a permanent part of the browser until removed. The permanence and accessibility of bookmarks have made them a valuable means for personalizing a user's Internet access through the browser. Typically a URL navigation graphical user interface (GUI) is used in Netscape Navigator or Microsoft's Explorer to allow an end-user to simply click on one of a number of listed URL's or titles of URLs and be directly connected to the URL link or website on network such as the internet.

The large number of bookmarks that a user maintains in bookmark lists becomes difficult to manage and use and it is difficult to remember which bookmarks and URLs have been saved. It is not uncommon that hundreds of bookmarks be stored in a bookmark list file after a few weeks of Web browsing. While folders in some browsers have helped the user group his bookmarks by category, in reality, the bookmark file is one huge list of bookmarks, all accessible to the user through the browser.

These problems as well as others are addressed in various embodiments of the present invention.

### SUMMARY OF THE INVENTION

URL database software stored in machine readable format includes database software and system for storing URL links in a database on an end-user computer. The database has records and each of the records has at least three fields relating to a single URL link which is stored in a first field. A second field is used to store an editable URL title and a third field is used to store user entered notes. A URL navigation means is used to navigate and connect said end-user computer to a URL site associated with a selected one of at least one of said first, second, and third fields of said records displayed by said URL navigation means. A database graphical user interface displays the second field of the URL titles, has a means for a user to select a record by selecting one of the displayed URL titles, and displays associated ones of the second field of the URL links and notes from the selected record. In an exemplary embodiment of the invention disclosed herein, the database graphical user interface further includes a means for entering the URL links in the first fields, a means for entering the URL titles in the second fields, and a means for entering notes in the third fields. One means for entering the URL links in the first fields includes a Web browser on the end-user computer with a means to find and select a URL link and an add button on the database graphical user interface to enter a selected URL link in one of the first fields.

In a more particular embodiment of the invention, the software further includes a means for grouping the URL links and associated records in selectable groups displayed on a screen displayed by the database graphical user interface. The database graphical user interface includes a means for entering the URLs in the first fields of a categorized record in a selected group, a means for entering the URL titles in the second fields of the categorized record, and a means for entering notes in the third fields of the categorized record. Another embodiment includes a means for selecting one or more of the groups to be hidden from display on the screen displayed by a URL navigation graphical user interface. Yet another embodiment includes a means for selecting one or more of the records in one of the groups to be hidden from display on the screen displayed by the URL navigation graphical user interface. Sort and search means and an automated log-in means are provided in the graphical user interface of more particular embodiments of the invention.

The present invention helps manage large number of bookmarks or favorites that a user maintains in bookmark or favorites lists.

### BRIEF DESCRIPTION OF THE DRAWINGS

The novel features believed characteristic of the present invention are set forth and differentiated in the claims. The invention, together with further objects and advantages thereof, is more particularly described in conjunction with the accompanying drawings in which:

FIG. 1 is a screen shot illustration of an icon on a Microsoft Windows Desktop screen for launching “HOT SHOT” which is an exemplary embodiment of application software containing URL database software of the present invention.

FIG. 2 is a screen shot illustration of a first window displayed by the application software initiated by the icon illustrated in FIG. 1 with a button labelled “Favorites Plus” to launch the URL database software.

FIG. 3 is a screen shot illustration of two fields of records in the URL database software.

FIG. 4 is a screen shot illustration of a third field of records in the URL database software.

FIG. 5 is a screen shot illustration of a password means for storing log-in information in the URL database software.

FIG. 6 is a screen shot illustration of a first step in a means to add grouping of records in the URL database software.

FIG. 7 is a screen shot illustration of a second step in the means to add grouping of records in the URL database software.

FIG. 8 is a screen shot illustration of a group hiding means for selecting one or more of the groups to be hidden from display on the screen displayed by the graphical user interface.

FIG. 9 is a screen shot illustration of results of the group hiding means illustrated in FIG. 8.

FIG. 10 is a screen shot illustration of a record hiding means for selecting one or more of the records to be hidden from display on the screen displayed by the graphical user interface.

FIG. 11 is a screen shot illustration of results of the record hiding means illustrated in FIG. 10.

FIG. 12 is a screen shot illustration of a group unhiding means for selecting one or more hidden groups to be unhidden.

FIG. 13 is a screen shot illustration of a unchecking a hidden group.

FIG. 14 is a screen shot illustration of results of the group unhiding illustrated in FIGS. 12 and 13.

FIG. 15 is a screen shot illustration of a link unhiding means for selecting one or more hidden links to be unhidden.

FIG. 16 is a screen shot illustration of a URL import means for importing URLs found using a browser into the URL database.

FIG. 17 is a screen shot illustration of results of the link unhiding illustrated in FIGS. 15 and 16.

FIG. 18 is a screen shot illustration of a URL import means for importing URLs found using a browser into the URL database.

FIG. 19 is a screen shot illustration of a search means for searching on terms in the records of the URL database.

### DETAILED DESCRIPTION

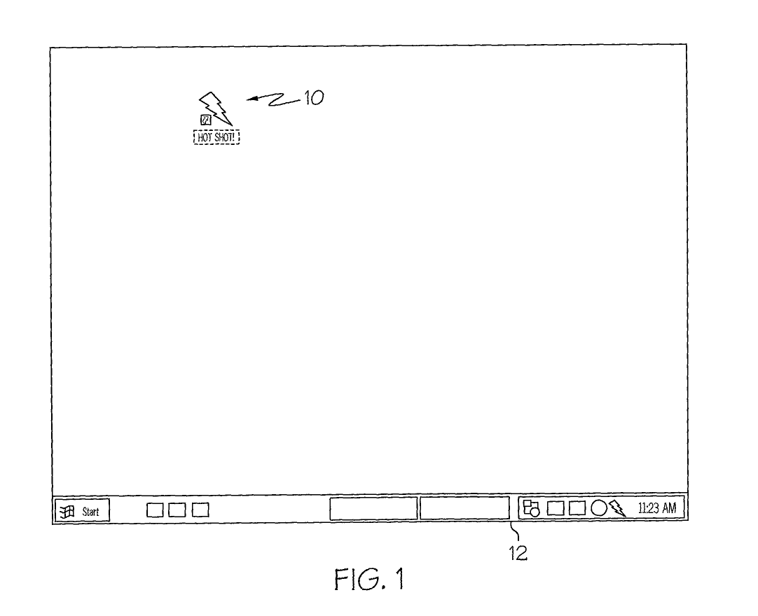

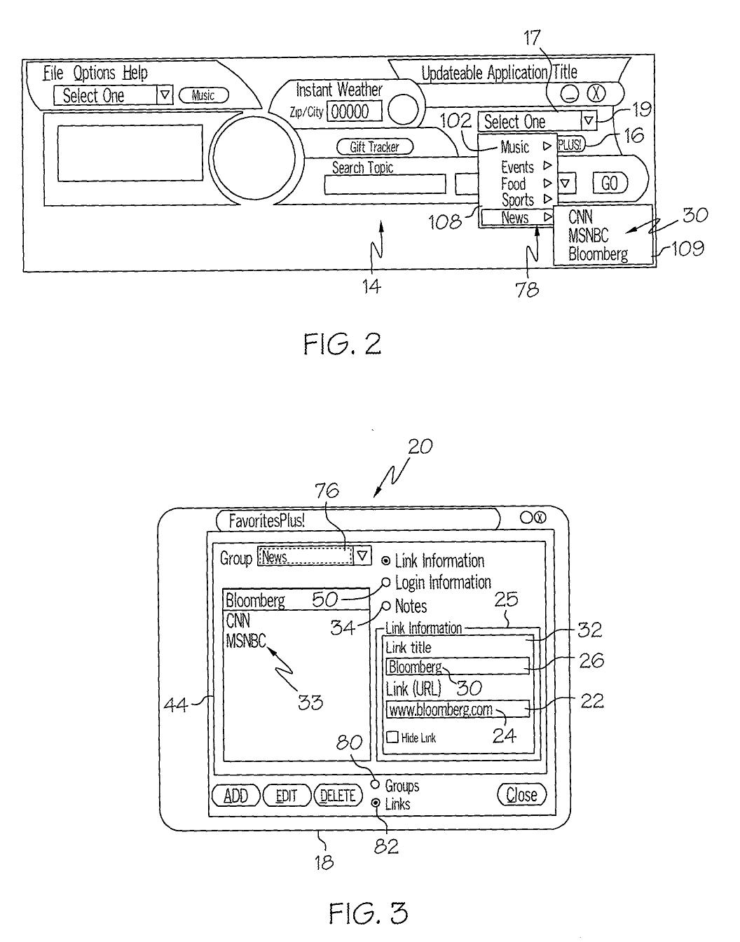

Illustrated in FIG. 1 is an application icon 10 labeled Hot Shot which appears on a Microsoft desktop screen 12 of an end-user computer monitor and which invokes an exemplary windows application entitled Hot Shot. Hot shot includes an exemplary embodiment of URL database software of the present invention which is entitled Favorites Plus! in the FIGS. The exemplary embodiment of URL database software is stored in machine readable format and operably associated with the end-user computer. When the Hot Shot application is invoked, a first window 14 (illustrated in the form of a banner) is displayed as illustrated in FIG. 2. The present invention employs a database graphical user interface illustrated herein as a plurality of windows to input and view information in the database software and execute software functions. In the exemplary embodiment of the invention, the URL database software is stored on the end-user computer. The software in the exemplary embodiment of the invention is in object oriented computer code used by many software programmers. The means of the present invention are in the form of computer codes that may be written as computer programs or sub-programs or sub-routines of computer programs as well as object code. The means further may in various embodiments include typical computer features and components such as graphical user interfaces (GUI) and computers and computer systems.

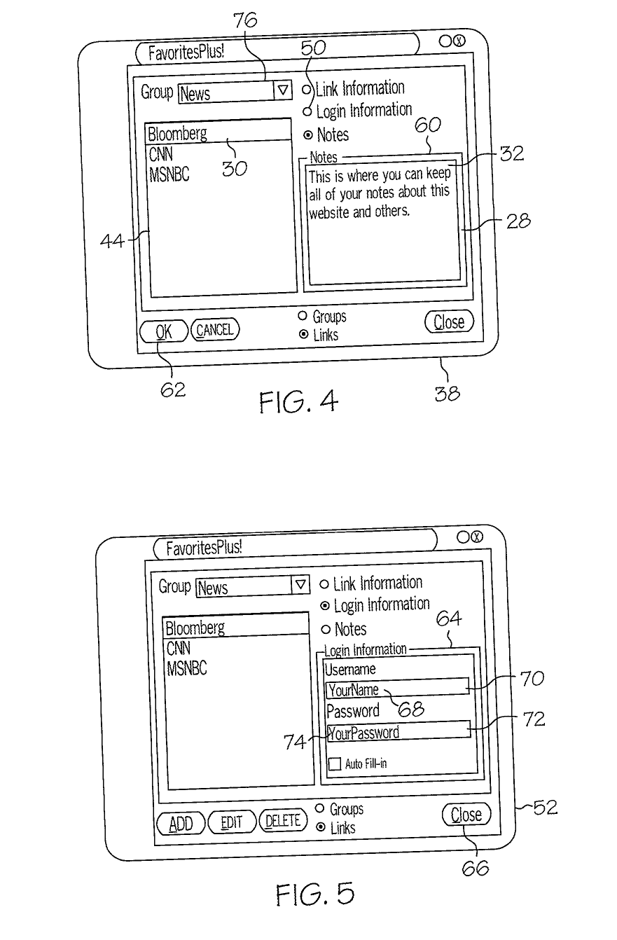

The URL database software includes a database means for storing URL bookmarks or favorites, as illustrated herein, in a URL database on the end-user computer. The URL database software is described herein using various windows that illustrate the software's operation and functions. Clicking on a Favorites Plus! button 16 brings up a second window 18 illustrated in FIG. 3 used to store, index, and manage information in the URL database. The URL database contains records 20 wherein each of the records relates to or is associated with a single URL 24. Each record 20 has at least three fields illustrated by first and second fields 22 and 26 in a Link Information box 25 illustrated in FIG. 3 and a third field 28 illustrated in FIG. 4.

The first field 22 contains the URL 24, the second field 26 contains an editable URL title 30, and the third field is used to store user entered notes 32. The second window 18 in FIG. 3 displays a titles window 44 containing a URL title list 33 of the URL titles 30 from the second fields and a user may select a record for editing by clicking on one of the displayed URL titles in the title list. Clicking on a notes button 34 in the second window 18 in FIG. 3 brings up a fourth window 38 illustrated in FIG. 4 which displays the notes 32 in the third field 28 for the selected URL 24. The notes are particular to the selected URL and upon completion of the entry of the notes into a Notes box 60, the information is saved or stored by clicking on an OK button 62. A record may be selected for editing or for reviewing the information in the fields of the record by clicking on one of the URL titles 30 displayed in the titles window 44 in FIGS. 3 and 4. Information or notes about the record or URL may be entered into the third field 28, such as descriptive terms or reminders. Illustrated further down in the patent is a searching means, as commonly found in database applications, to search the fields such as the URL title 30 and/or the notes 32.

The exemplary embodiment of the invention illustrated herein includes a password means for storing log-in information which allows the end-user to record a script of a sequence of keystrokes performed to log-in to a password secured URL, to save the script to a field in the database, generate a log-in script which the browser will run whenever it detects the end-user navigating to the password secured URL with the defined script, and automatically log the end-user in to the password secured URL. The means for storing log-in information is illustrated in FIGS. 3 and 4 as a log-in information button 50. Clicking on the log-in information button 50 brings up a fifth screen 52 illustrated in FIG. 5 further illustrating the password means for storing log-in information. The password means allow the user to enter log-in information such as a user name 68 and Password 74 into fourth and fifth fields 70 and 72, respectively, of appropriate ones of the records 20 illustrated in a Log-In Information box 64 in the fifth screen 52. The password means records a script of a sequence of keystrokes performed to log-in to a password secured URL using a password and usually a user name also. The user name and password are, of course, particular to the selected URL and upon completion of the entry of the user name and password, the information is stored by clicking on the Close button 66.

Note that for embodiments of the invention illustrated herein, an ADD button 48 is used in these above windows to provide a means for entering the URLs in the first fields, a means for entering the URL titles in the second fields, and a means for entering notes in the third fields. Clicking on the ADD button allows the end-user to enter the associated information in the fields. An Edit button 63 is used to change fields and an OK button 62 or the Close button 66 saves the additions or changes to the various entries, records, and fields that are made. Information may be added using the keyboard to type in the information in the records.

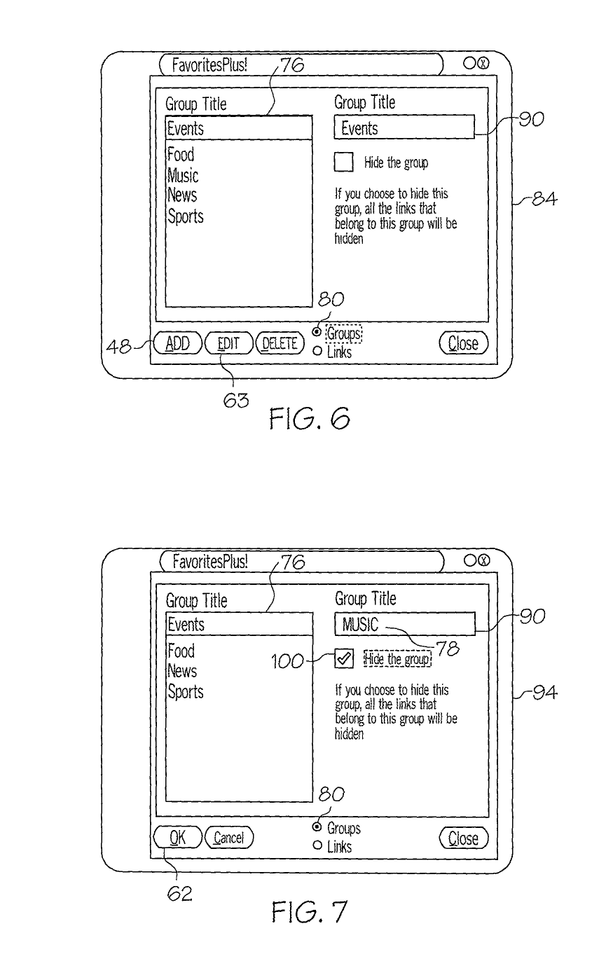

The exemplary embodiment of the invention illustrated herein includes a means for grouping the URL bookmarks and associated records in selectable categories or groups illustrated by group titles 78 displayed on a screen of the database graphical user interface. This feature is illustrated in FIGS. 3 and 4 as a group title box 76 which displays the group titles 78 which the end-user enters using the second window 18 illustrated in FIG. 3. Either a Groups button 80 or a links button 82 is elected by the end-user to edit groups and group information for the group titles 78 in the group title box 76. Each group contains records and displays a default group title for records not assigned to a group such as a term “no group” in the group title box 76. Clicking on the Groups button 80 brings up a sixth screen 84 illustrated in FIG. 6 having the group title box 76 and the ADD button 48. Clicking on the ADD button 48 brings up a seventh screen 94 illustrated in FIG. 7 which allows the user to enter a new group title 78 such as MUSIC in a group title entry box 90 which is then saved and added to the group title box 76 by clicking on the OK button 62. This returns the end-user to the sixth screen 84 illustrated in FIG. 6 which would then display the just added group title 78 MUSIC in the group title box 76.

The URL database software includes a URL navigation means for navigating to sites of URLs in the records using a web browser. One exemplary embodiment of the URL navigation means is illustrated in FIGS. 2 and 11. The URL navigation means illustrated herein has a URL navigation graphical user interface that includes a menu selection box 17 illustrated first in FIG. 2 and a favorites pull-down menu 108 illustrated in FIG. 11 which is displayed by clicking on a menu opening button 19 in the selection menu box. The pull-down menu 108 displays a Groups List 102 containing the different URL titles 30 or group titles 78. If groups are used then URL tiles of records in the displayed groups are displayed within sub-menus 109 of the pull-down menu 108. Clicking on one of the URL titles 30 will cause the associated URL link to open.

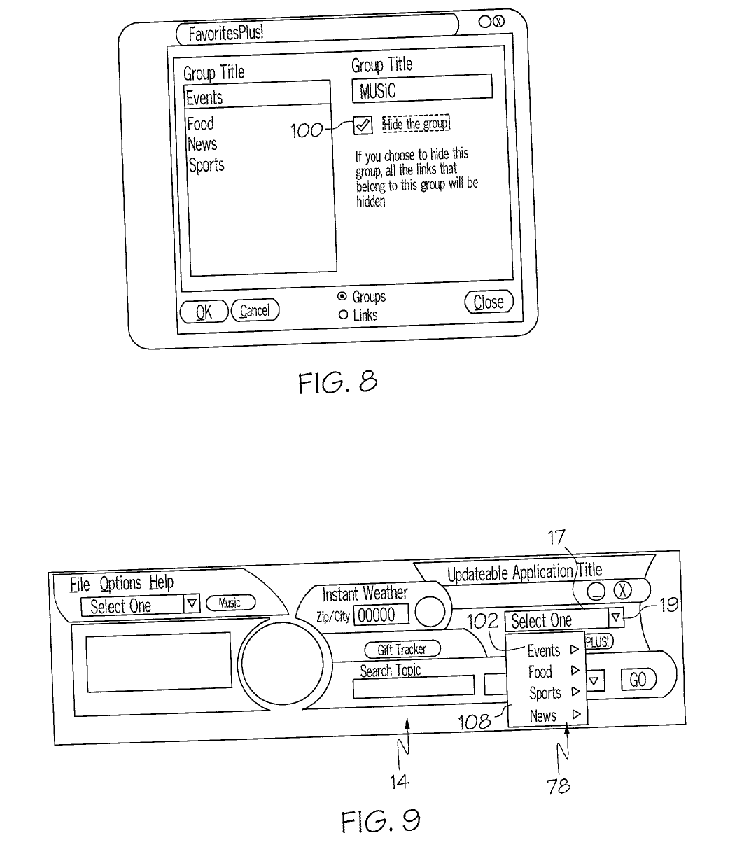

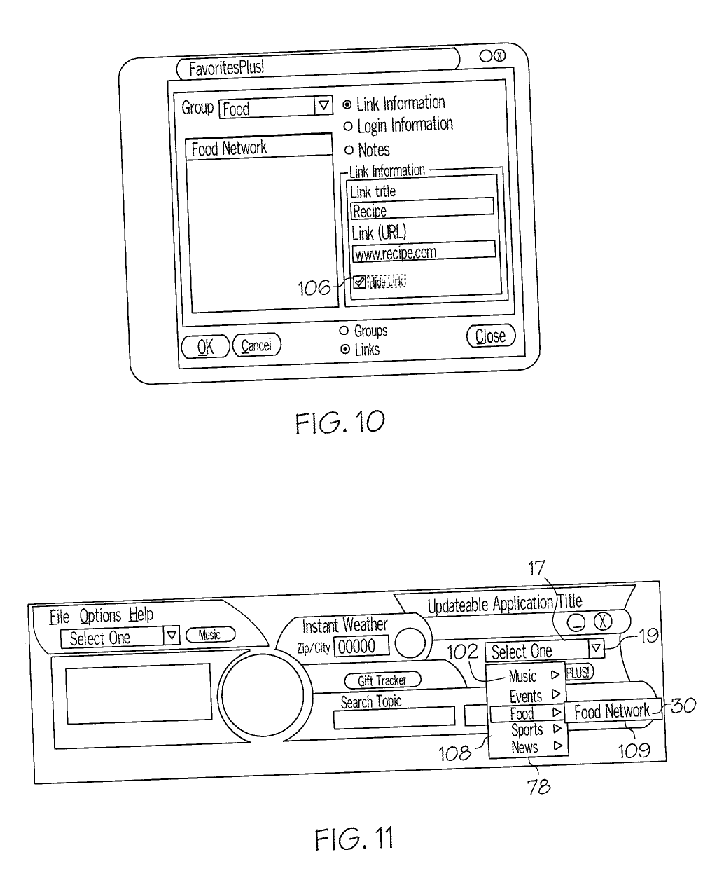

The exemplary embodiment of the invention also includes group hiding and unhiding means for selecting one or more of the groups to be hidden and unhidden from display on the screen displayed by the URL navigation graphical user interface of the URL navigation means illustrated in FIGS. 2 and 11. The group hiding means is illustrated in the exemplary embodiment starting with the sixth screen 84 illustrated in FIG. 6. A group which is to be hidden is selected from the group titles 78 in the group title box 76 and then the Edit button 63 is clicked which brings up the seventh screen 94 illustrated in FIG. 7. The group hiding means allows the end-user to hide a group by checking or clicking upon the hide group check box 100. For example, the group Music is hidden by checking the group check box 100 such as illustrated in FIG. 8. FIG. 9 illustrates the result of hiding a group in the Favorites Plus application and as can be seen the Groups List 102 does not include Music which was hidden in the step illustrated in FIG. 8. The exemplary embodiment of the invention also includes a record hiding means for selecting one or more of the records to be hidden from display on the screen displayed by the graphical user interface as illustrated in FIG. 10. A link or record is hidden by checking the Hide Link records check box 106. For example, the link or record Recipe is hidden by checking the Hide Link records check box 106. FIG. 11 illustrates the change in the Favorites Plus application under a favorites pull-down menu 108 which now does not include the Recipe record or link which was hidden in the step above.

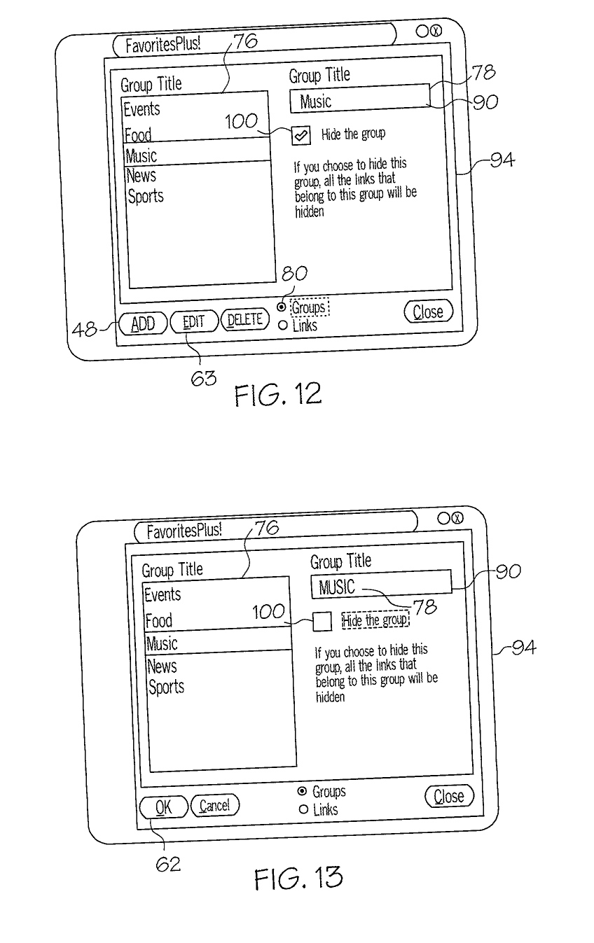

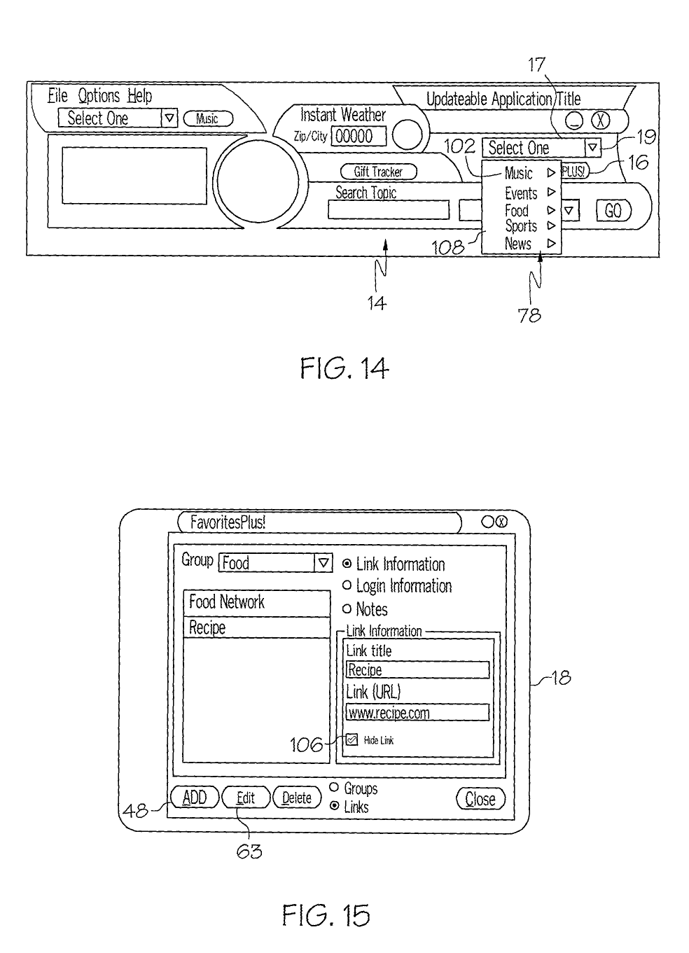

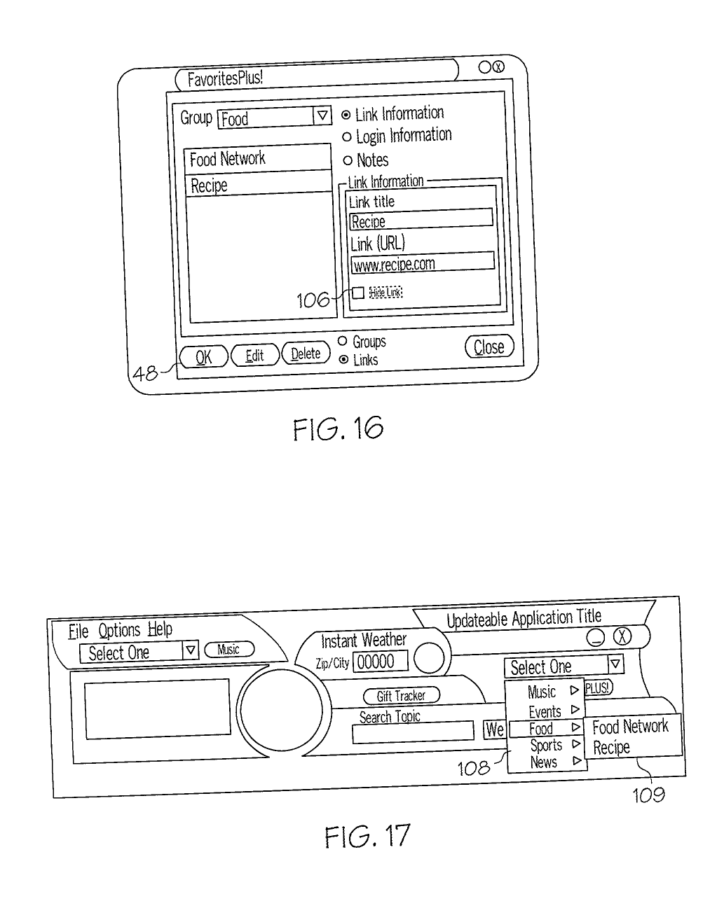

A means to unhide a group such that it will again be displayed on the screen displayed by the URL navigation graphical user interface of the URL navigation means is illustrated in FIGS. 12 and 13. The Group to be unhidden is selected then the Edit button 63 is clicked upon as illustrated in FIG. 12. Next, the hide group check box which is checked is unchecked by clicking the cursor within the box and the change is saved by clicking on the OK button 62 as illustrated in FIG. 13. As illustrated in FIG. 14, these steps result in the Groups List 102 now again displaying the Music group, for example, which was previously hidden in the step illustrated in FIG. 8. A means to unhide a hidden link uses the same general procedure as unhiding a group. A means to unhide a link is illustrated in FIG. 15 starting with the second window 18, the hidden link is unhidden by selecting the link to unhide, for example recipe, clicking on the Edit button 63, then uncheck the Hide Link records check box 106 by clicking on it as illustrated in FIG. 16 and save the change is saved or stored by clicking on an OK button 62. The unhidden link will then reappear on the link list in the sub-menu 109 of Recipe in the pull-down menu 108 illustrated in FIG. 17.

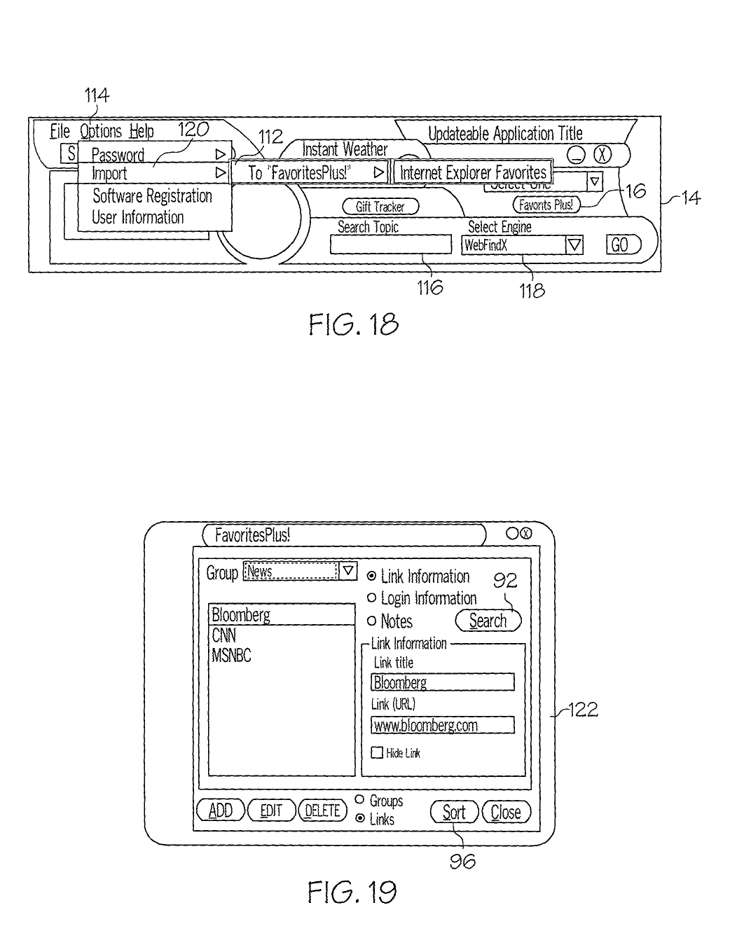

The browser may be used to search the internet or an intranet or other system containing URLs. Typically, browsers allow URLs of sites to be saved as favorites or bookmarks. FIG. 18 illustrates a URL import means for importing URLs found using a browser into the URL database containing records 20 of the present invention. This feature is illustrated herein in the “HOT SHOT” application software which includes an import drop-down menu 112 illustrated in the first window 14 which offers choice of importing favorites from favorites list of microsoft's explorer browser using the Import button 120. The import drop-down menu 112 is brought up by clicking on an Options button 114. The “HOT SHOT” application software includes its own searching means illustrated by Search Topic box 116 and Select Engine box 118. Alternatively, the import drop-down menu can be set to import a single URL or choices in the list of favorites in the browser. Another alternative is to have a menu option to import a current URL to which the end-user's computer is linked.

Another embodiment of the invention includes a search means for searching on terms in the records as illustrated by a Search button 92 illustrated in an eighth screen 122 illustrated in FIG. 19. Alternatively, the list of groups or the notes may be searched separately. Another embodiment of the invention includes a sort means for sorting records in a group or sorting the groups searching on terms in the records as illustrated by a Sort button 96 on the eighth screen 122 illustrated in FIG. 19. Terms to be searched on the database may be entered on a pop-up menu with a search item entry box. The sort means provides choices of ascending or descending sorting either numerically or alphabetically and choices may appear on a pop-up menu. Searching and sorting are well known means in the fields of databases and spread sheets.

While the preferred embodiment of the present invention has been described fully in order to explain its principles, it is understood that various modifications or alterations may be made to the preferred embodiment without departing from the scope of the invention as set forth in the appended claims.

Accordingly, what is desired to be secured by Letters Patent of the United States is the invention as defined and differentiated in the following claims:

What is claimed is:

1. URL database software stored in machine readable format for use on an end-user computer, said URL database software comprising:
a database means for storing URL links in a database on the end-user computer,
said database having records and each of said records having at least three fields relating to a single URL link which is stored in a first field,
a second field is used to store an editable URL title,
a third field is used to store user entered notes, and
a URL navigation means for navigating the end-user computer to a URL site associated with a selected one of at least one of said first, second, and third fields of said records displayed by said URL navigation means.

2. Software as claimed in claim 1 further comprising:
an indexing graphical user interface including;
a means for entering said URL links in said first fields,
a means for entering said URL titles in said second fields, and
a means for entering notes in said third fields.

3. Software as claimed in claim 2 wherein said means for entering said URL links in said first fields includes a Web browser on the end-user computer with a means to find and select a URL link and a save means on said graphical user interface to enter a selected URL link in one of said first fields.

4. Software as claimed in claim 1 further comprising a means for grouping said the URL links and associated records in selectable groups displayed on a screen displayed by said graphical user interface.

5. Software as claimed in claim 4 wherein said graphical user interface further comprises;
a means for entering said URLs in said first fields of a categorized record in a selected group,
a means for entering said URL titles in said second fields of said categorized record, and
a means for entering notes in said third fields of said categorized record.

6. Software as claimed in claim 5 wherein said means for entering said URLs in said first fields includes a Web browser on the end-user computer with a means to find and select a URL and a save means on said graphical user interface to enter a selected URL in one of said first fields of said categorized record.

7. Software as claimed in claim 4 further comprising a group hiding means for selecting one or more of said groups to be hidden from display on said screen displayed by said graphical user interface.

8. Software as claimed in claim 7 further wherein said graphical user interface further comprises;
a means for entering said URLs in said first fields,
a means for entering said URL titles in said second fields, and
a means for entering notes in said third fields.

9. Software as claimed in claim 8 wherein said means for entering said URLs in said first fields includes a Web browser on the end-user computer with a means to find and select a URL and a save means on said graphical user interface to enter a selected URL in one of said first fields.

10. Software as claimed in claim 1 further comprising a means for searching a displayed one of said fields.

11. Software as claimed in claim 1 further comprising a search means for searching said records.

12. Software as claimed in claim 11 wherein said means for entering said URL links in said first fields includes a Web browser on the end-user computer with a means to find and select a URL link and a save means on said graphical user interface to enter a selected URL link in one of said first fields.

13. Software as claimed in claim 10 further comprising a means for grouping said the URL links and associated records in selectable groups displayed on a screen displayed by said graphical user interface.

14. Software as claimed in claim 13 wherein said graphical user interface further comprises;
a means for entering said URLs in said first fields of a categorized record in a selected group,
a means for entering said URL titles in said second fields of said categorized record, and
a means for entering notes in said third fields of said categorized record.

15. Software as claimed in claim 14 wherein said means for entering said URLs in said first fields includes a Web browser on the end-user computer with a means to find and select a URL and save means on said graphical user interface to enter a selected URL in one of said first fields of said categorized record.

16. Software as claimed in claim 13 further comprising a group hiding means for selecting one or more of said groups to be hidden from display on said screen displayed by said graphical user interface.

17. Software as claimed in claim 16 further wherein said graphical user interface further comprises;
a means for entering said URLs in said first fields,
a means for entering said URL titles in said second fields, and
a means for entering notes in said third fields.

18. Software as claimed in claim 17 wherein said means for entering said URLs in said first fields includes a Web browser on the end-user computer with a means to find and select a URL and a save means on said graphical user interface to enter a selected URL in one of said first fields.

19. Software as claimed in claim 1 further comprising a record hiding means for selecting one or more of said record to be hidden from display on said screen displayed by said graphical user interface.

20. Software as claimed in claim 19 wherein said graphical user interface further comprises;
a means for entering said URL links in said first fields,
a means for entering said URL titles in said second fields, and
a means for entering notes in said third fields.

21. Software as claimed in claim 20 wherein said means for entering said URL links in said first fields includes a Web browser on the end-user computer with a means to find and select a URL link and a save means on said graphical user interface to enter a selected URL link in one of said first fields.

22. Software as claimed in claim 19 further comprising a means for grouping said the URL links and associated records in selectable groups displayed on a screen displayed by said graphical user interface.

23. Software as claimed in claim 22 wherein said graphical user interface further comprises;
a means for entering said URLs in said first fields of a categorized record in a selected group,
a means for entering said URL titles in said second fields of said categorized record, and
a means for entering notes in said third fields of said categorized record.

24. Software as claimed in claim 23 wherein said means for entering said URLs in said first fields includes a Web browser on the end-user computer with a means to find and select a URL and a save means on said graphical user interface to enter a selected URL in one of said first fields of said categorized record.

25. Software as claimed in claim 19 further comprising a password means for storing log-in information which allows storage of a script of a sequence of keystrokes performed to log-in to a password secured URL, to save script to a password field in said database, generate a log-in script which a browser will run whenever it detects the end-user navigating to the password secured URL with the defined script, and automatically log-in to said password secured URL.
